(19) United States
(12) Patent Application Publication
(10) Pub. No.: US 2007/0204334 A1
(43) Pub. Date: Aug. 30, 2007

(54) Information security protection method based on network software and the data security control system thereof

(75) Inventors: Zhou Lu, Beijing (CN); Huazhang Yu, Beijing (CN)

Correspondence Address: SCULLY SCOTT MURPHY & PRESSER, PC, 400 GARDEN CITY PLAZA, SUITE 300, GARDEN CITY, NY, 11530, US

(73) Assignee: Feitian Technologies Co., Ltd., Beijing (CN)

(21) Appl. No.: 11/649,563

(22) Filed: Jan. 4, 2007

(30) Foreign Application Priority Data
Mar. 17, 2006 (CN) 200610065117.3

(51) Int. Cl. H04L 9/32

(52) U.S. Cl. 726/9

(57) ABSTRACT

By setting up a dongle on the service side host, the present invention allows multiple client side hosts connected to the service side host to share a software protection product (a dongle herein) and due to the key information of the protected software is stored within the dongle, the client side hosts must interact with the dongle to operate the software properly. The access from the client side is controlled and monitored by the service side. The individual clients can share a dongle to use the protected software respectively. Besides protecting the software, the number of the software protection apparatuses in use is reduced by sharing them, so that the cost is reduced as a result. The centralized management and control of the service side make it possible for the clients to access the dongle in a time-sharing manner. The clients can continually interact with the dongle or stop using the software according to the response from the dongle.

### FIELD OF THE INVENTION

The present invention relates to a protection method and the apparatus thereof for network software, and more particularly, to an information security protection method based on network software and the apparatus thereof.

### BACKGROUND OF THE INVENTION

In now days, the software orienting a particular application field or industry demand is developed increasingly. And the new software protection products are also manufactured constantly. The price of a software protection product depends mostly on its security. High security is derived from good chip and elaborate development. Therefore, a software protection product with high security must be highly priced.

With the advances in computer network technologies and the increasingly widespread network applications, many problems (e.g. data communication, remote transmission, centralized management, distributed processing and load balancing) are solved. Thus it is considered that we can share software protection products via the network. Currently, each client is coupled with a hardware dongle, which is a kind of software protection product. However, the cost for software protection is relatively high and the dongle running the network software is to some extent fixed (when the client user changes frequently, it is required to pull and plug the dongle accordingly), which makes more inconvenience to the user.

### SUMMARY OF THE INVENTION

The present invention overcomes the above defects and provides a low-cost and flexible-application information security protection method based on network software and the apparatus thereof.

The solution of the present invention to the technical problems is: an information security protection method based on network software, in which a client side host is connected to a service side host via the network, and the service side host is equipped with a dongle; and comprising the following steps of:
1) the client side sending a login request to the service side, and the service side forwarding this request to the dongle;
2) the dongle recording the clients requesting for login, and judging whether the number of the clients logging in will exceed the limit number: if it does, proceeding to an exceptional process; otherwise, allowing the clients to log in and authorizing the clients to use it;
3) the dongle interacting with the client side and the operations of the client side continuing.

In Step 1, when more than one client sends login requests to the service side at the same time, the service side will prioritize the requests and forward the requests to the dongle orderly.

In Step 2, when authorizing the clients to use the dongle, the service side also retrieves the client side information, including the client side's network identifier, the communication protocol in use, and the login time.

The service side monitors the clients by using the client side information it has retrieved, and stops the clients in illegal use forcibly.

In Step 3, the data interaction between the dongle and the client side involves writing, reading, or running.

A data security control system based on network software sharing, comprising a service side host and some client side hosts connected to it via the network; the protected software is installed on the client side hosts, and the service side host is equipped with a dongle to store or run the key information of the protected software; the dongle comprises an interface module and a master unit connected to the interface module; the interface module is used for connecting to the service side host and resolving the communication protocol; the master unit further comprises a microprocessor; and the microprocessor is integrated with the interface module or is separate from the interface module.

The master unit in the dongle may further comprise the extension memories, such as RAM, ROM, EPROM, EEPROM, and FLASH, or the combination of them, which are connected to the microprocessor and are used for storing certain encryption algorithms.

The protected software is also installed on the service side host.

The microprocessor may be a microprocessor chip comprising a Single Chip Micyoco (SCM), a Micro Controller Unit (MCU), a Central Processing Unit (CPU) or a smart card.

The interface module may be a Universal Serial Bus (USB) interface, a parallel interface, a wireless USB interface, a Bluetooth interface, an infrared interface, or a 1394 interface.

By setting up a dongle on the service side host, the present invention allows multiple client side hosts connected to the service side host to share a software protection product (a dongle herein) and due to the key information of the protected software is stored within the dongle, the client side hosts must interact with the dongle to operate the software properly. The access from the client side is controlled and monitored by the service side. The individual clients can share a dongle to use the protected software respectively. Besides protecting the software, the number of the software protection apparatuses in use is reduced by sharing them, so that the cost is reduced as a result. The centralized management and control of the service side make it possible for the clients to access the dongle in a time-sharing manner. The clients can continually interact with the dongle or stop using the software according to the response from the dongle.

### BRIEF DESCRIPTION OF THE DRAWINGS

The present invention may be further understood from the following description in conjunction with the appended drawings. In the drawings:

FIG. 1 is a structure schematic of the first embodiment of the present invention;

FIG. 2 is a structure schematic of the second embodiment of the present invention;

FIG. 3 is a structure schematic of the third embodiment of the present invention;

FIG. 4 is the software protection control flow diagram of the present invention.

### DETAILED DESCRIPTION OF THE EMBODIMENTS

The network software usually runs on several client side hosts at the same time. The protected software is installed on the client side hosts. The service side host is equipped with a dongle for storing or running the key information of the protected software.

The dongle can be embodied in various ways. Referring to FIG. 1, the first embodiment comprises a CPU 105 and an interface module 103 connected to the CPU. The CPU is also connected to an extension memory 104.

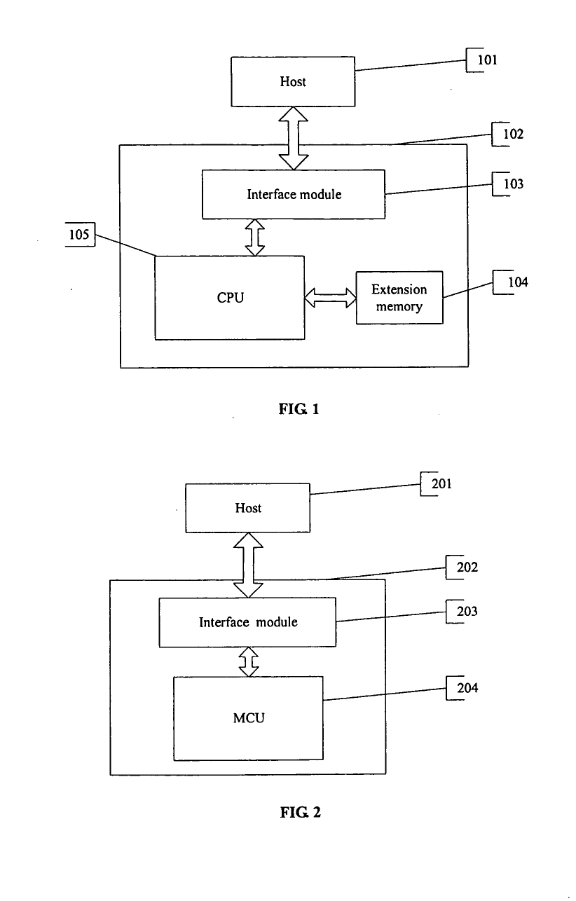

Referring to FIG. 2, the second embodiment comprises a MCU 204 that is integrated with a memory and an interface module 203 for resolving the communication protocol.

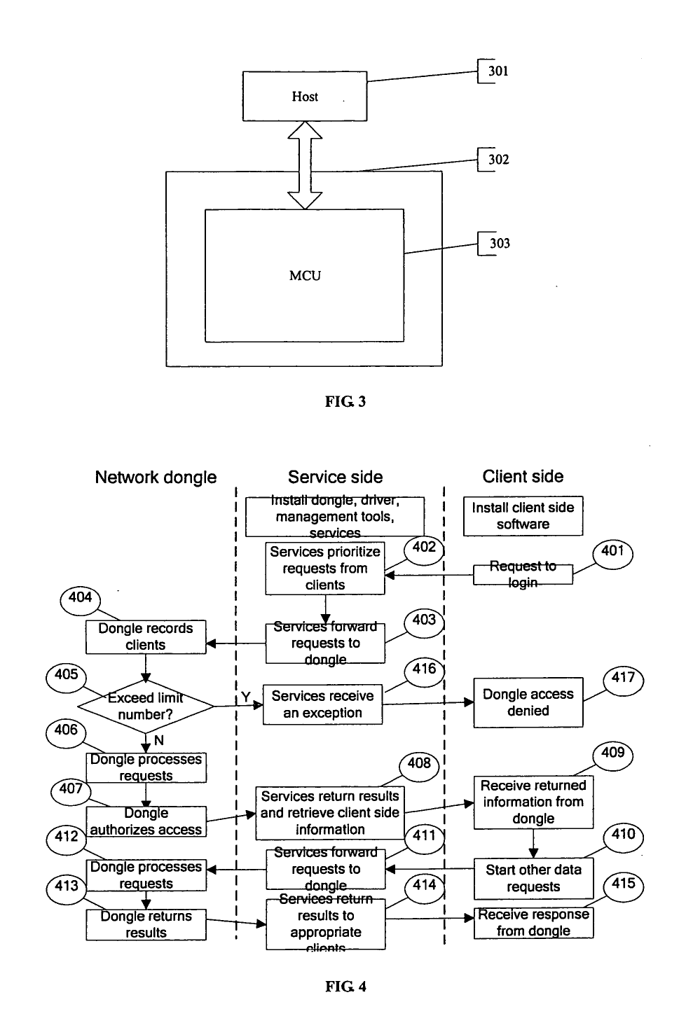

Referring to FIG. 3, the third embodiment comprises a MCU 303 that is integrated with a memory and an interface module, and is connected to the host.

As a master unit, the CPU or MCU is used to run firmware programs and user programs, and can also be replaced with a microprocessor chip of SCM or smart card. The memory is used to store device firmware programs, user data, status information and certain encryption algorithms, and may be RAM, ROM, EPROM, EEPROM, or FLASH etc. The memory should have enough storage space to store preset encryption algorithms. Or, the user can choose or download algorithms. Note that more enough storage space is required if the memory is also used to store some user code. Using a USB HID (Human Interface Device) interface chip, the interface module 103/203 is used to resolve the communication protocol when the apparatus communicates with the host. The firmware programs contain the following components: recognizing the apparatus, the apparatus waiting for and receiving data from the host, the apparatus resolving and processing the data, the apparatus returning data to the host and waiting for the next instruction and the apparatus disconnecting to the host. Once the apparatus is recognized by the host, the apparatus will establish a connection to the host with the information in the register of the MCU.

The dongle and the configuration file are installed on the service side. If a driver is necessary for the dongle, it can be installed on the service side, too. The client configuration file is stored on the client side. The service side and client side services retrieve network configuration information from the configuration file. The protocol type, response time, server address and other required information can be set up with the configuration file.

The following operations are identical for the foregoing embodiments. Referring to FIG. 4, after the service side has installed a dongle, the services start to run and wait for the access of the client side. First, the client side runs native software and connects to the services on the service side via the network to access the dongle. As shown in Step 401, the client side requests to log in the dongle. As shown in Step 402, the services on the service side then determine to prioritize the requests from the individual clients. Next, the service side forwards the requests of the clients to the dongle orderly in Step 403. For the clients trying to log in, the dongle will record them, as shown in Step 404, and judge whether the number of clients has exceed the limit number, as shown in Step 405. If it does, the services will receive an exception which can be used by the management tools, as shown in Step 416. When the service side has received the exception, it will reject the clients to use the dongle, as shown in Step 417. Otherwise, if the number is within the limit, the dongle will process the login requests in Step 406 and authorize the clients to use it in Step 407. Next, the services will return the results to the clients and retrieve information from the clients, as shown in Step 408. The clients receive the returned information from the dongle in Step 409, and start making other requests in Step 410. The services forward the requests to the dongle in Step 411. Then, the dongle processes the data requests from the clients in Step 412 and returns the processing results to the service side in Step 413. The service then forwards these results to the appropriate clients in Step 414. Finally, the clients receive the response from the dongle in Step 415.

When the requests from the clients are completed, the dongle removes the records corresponding to it.

In particular, if the client side itself is the service side, i.e. the service side contains the protected software as well as the client side, the process is exactly the same as that in case that the client side and the service side are different hosts, except that the programs on the client side and the programs on the service side are just installed on the same machine.

In case that more than one client accesses the service side at the same time, the services on the service side can assign the requests from the clients to make the clients gain the access to the dongle in a time-sharing manner, return the resulting data to the clients orderly.

The service side can limit the clients accessing the dongle at the same time by the maximum number of users, which is stored in the hardware of the dongle. Thus the developer can control the use of the software after distribution.

The service side monitors the clients on the network via the client side information it retrieves, such as the network identifier, the communication protocol in use, the login time and the like. For example, whether the client side is using the correct communication protocol can be monitored. The service side can forcibly terminate the clients with one of its features. The management tool is helpful in checking the errors on the client side and of course it can also restrict the illegal use.

In the previous process, the services run on the server; multiple clients can operate the native protected software at the same time and connect to the services on the service side via the network, then the services can control the access to the dongle in a time-sharing manner by centralized management and assignment; and the clients can continue or stop using the software which depends on the response from the dongle.

The key information of the protected software is stored in the dongle, so that the client side must interact with the dongle to operate the software correctly. The access from the clients is controlled and monitored by the service side. The individual clients can share a dongle to use the protected software on their own.

In addition, it is not a must to use a specific server to run the service side programs and connect a software protection apparatus. Any client side host can become a service side host by holding and running the service side programs and connecting the software protection apparatus.

The software protection apparatus, like the dongle, is used to encrypt the software. It can protect the programs from unauthorized duplication, and prevent the programs from being illegally tracked, debugged, dumped, and decompiled, especially it can be shared in the present invention. The software users need to buy only one dongle, so that multiple users can use the software protected by this dongle from multiple clients at the same time. Therefore, not only the software is protected, but the investment in the dongle is reduced indeed. As a result, the cost for using the software suite is cut down.

Moreover, by using the hard encryption technology, the limitation to the number of nodes is transferred to run within the dongle, which resolves the problems with legacy dongles that only use software to authorize and manage the terminals.

Currently, there are many types of computer peripheral interfaces. A lot of applications specific to the USB interface, the parallel interface, the wireless USB interface, the Bluetooth interface, the infrared interface, the 1394 interface or the like are developed. These interfaces are supported for the dongle of the present invention by simply replacing the interface chip module with the appropriate type of interface chip module.

The information security protection method based on network software and the apparatus thereof according to the present invention are described in details above. It will be appreciated by those of ordinary skill in the art that the invention can be embodied in other specific forms without departing from the spirit or essential character thereof. The presently disclosed embodiments are therefore considered in all respects to be illustrative and not restrictive. The scope of the invention is indicated by the appended claims rather than the foregoing description, and all changes which come within the meaning and range of equivalents thereof are intended to be embraced therein

1. An information security protection method based on network software, in which the client side hosts are connected to the service side host via the network, wherein the service side host is equipped with a dongle; comprising the following steps of:
1) the clients sending login request to the service side, and the service side forwarding the request to the dongle;
2) the dongle recording the clients requesting for login, and judging whether the number of the clients logging in will exceed the limit number: if it does, proceeding to an exceptional process; otherwise, allowing the clients to log in and authorizing the clients to use it;
3) the dongle interacting with the clients and the clients' operations continuing.

2. The method according to claim 1, wherein in Step 1, when more than one client sends login requests to the service side at the same time, the service sidewill prioritize the requests, and forward the requests to the dongle orderly.

3. The method according to claim 1, wherein in Step 2, when authorizing the clients to use the dongle, the service side also retrieves client side information, including the client side's network identifier, the communication protocol in use, and the login time.

4. The method according to claim 2, wherein in Step 2, when authorizing the clients to use the dongle, the service side also retrieve client side information, including the client side's network identifier, the communication protocol in use, and the login time.

5. The method according to claim 3, wherein the service side monitors the clients by using the client side information it has retrieved, and stops the clients in illegal use forcibly.

6. The method according to claim 4, wherein the service side monitors the clients by using the client side information it has retrieved, and stops the clients in illegal use forcibly.

7. The method according to claim 1, wherein in Step 3, the data interaction between the dongle and the client side involves writing, reading, or running.

8. The method according to claim 2, wherein in Step 3, the data interaction between the dongle and the client side involves writing, reading, or running.

9. A data security control system based on network software sharing, comprising a service side host and some client side hosts connected to it via the network, wherein the protected software is installed on the client side hosts, and the service side host is equipped with a dongle to store or run the key information of the protected software; the dongle comprises an interface module and a master unit connected to the interface module; the interface module is used for connecting to the service side host and resolving the communication protocol; the master unit further comprises a microprocessor; and the microprocessor is integrated with the interface module or is separate from the interface module.

10. The system according to claim 9, wherein the master unit in the dongle further comprises the extension memories, such as RAM, ROM, EPROM, EEPROM, and FLASH, or the combination of them, which are connected to the microprocessor and are used for storing certain encryption algorithms.

11. The system according to claim 9, wherein the protected software is also installed on the service side host.

12. The system according to claim 10, wherein the protected software is also installed on the service side host.

13. The system according to claim 9, wherein the microprocessor is a microprocessor chip comprising a Single Chip Micyoco (SCM), a Micro Controller Unit (MCU), a Central Processing Unit (CPU) or a smart card.

14. The system according to claim 10, wherein the microprocessor is a microprocessor chip comprising a Single Chip Micyoco (SCM), a Micro Controller Unit (MCU), a Central Processing Unit (CPU) or a smart card.

15. The system according to claim 9, wherein the interface module is a Universal Serial Bus (USB) interface, a parallel interface, a wireless USB interface, a Bluetooth interface, an infrared interface or a 1394 interface.

16. The system according to claim 10, wherein the interface module is a Universal Serial Bus (USB) interface, a parallel interface, a wireless USB interface, a Bluetooth interface, an infrared interface or a 1394 interface.
